(19) United States
(12) Patent Application Publication
(10) Pub. No.: US 2012/0061322 A1
(43) Pub. Date: Mar. 15, 2012

(54) Methods and Apparatuses for Treating a Dispersion Bath

(76) Inventors: Joachim Markowski, Sonsbeck (DE); James W. Martin, Eden Prairie, MN (US)

(21) Appl. No.: 12/880,800

(22) Filed: Sep. 13, 2010

(51) Int. Cl. B01D 15/04; B01J 47/00; B01D 24/10

(52) U.S. Cl. 210/668; 210/287; 210/206; 210/282; 210/291; 210/139

(57) ABSTRACT

The current method and apparatus relate to treating a dispersion bath using an ion exchange resin and an optional pH adjustor and wherein the ion exchange resin and the optional pH adjustor maintain a pH of within +/−2 of the initial pH of the dispersion bath.

### RELATED APPLICATION(S)

[Not Applicable]

### FIELD OF THE INVENTION

The present technology generally relates to methods and apparatuses for treating a dispersion bath. Specifically, the present technology includes methods and apparatuses for cleaning a contaminated dispersion bath from contamination caused by drag-in, aging and/or bacterial exchange. Specifically, the present technology also includes methods and apparatuses for improving the quality of a dispersion bath during manufacturing.

### BACKGROUND OF THE INVENTION

Printed circuit boards refer to solid circuits that are formed from a conductive material (commonly, copper or copper plated with solder or gold) that is positioned on opposite sides of an insulating material (commonly glass-fiber-reinforced epoxy resin). Where the printed circuit board has two conductive surfaces positioned on opposite sides of a single insulating layer, the resulting circuit board is known as a “double sided circuit board.” To accommodate even more circuits on a single board, several copper layers are sandwiched between boards of insulating material to produce a multi-layer circuit board.

In order to make electrical connections between the circuits on opposite sides of the double-sided circuit board, a hole is first drilled through the double-sided circuit board i.e., through the two conducting sheets and the insulator board. These holes are known in the art as “through holes.” Like the double-sided circuit boards, the multi-layer circuit boards also use “through holes” to complete circuits between the circuit patterns.

Various processes have evolved over the years for forming a conductive pathway between the various circuits, via the through hole. Co-owned U.S. Pat. Nos. 5,389,270, 5,476,580, 5,725,807, 5,690,805, 6,171,468, 6,303,181, 6,710,259 and 7,186,923 issued to Thorn et al. (collectively “the Thorn patents”) disclose improved compositions and processes for applying a conductive coating to an initially nonconductive through hole or other surface. The improved composition comprised a graphite colloid. U.S. Pat. Nos. 5,389,270, 5,476,580, 5,725,807, 5,690,805, 6,171,468, 6,303,181, 6,710,259 and 7,186,923 are hereby incorporated in their entirety.

The improved composition of the Thorn patents is typically applied to printed circuit boards using a dispersion bath, specifically a colloid bath. As a dispersion bath ages it can become contaminated by the printed circuit boards, the air and other contaminant sources. For example, nitrites and nitrates from bacteria can contaminate dispersion baths. As another example, sulfates from a fixer can contaminate dispersion baths. As yet another example, carbonate from excessive ammonia addition can also contaminate dispersion baths.

When a dispersion bath is contaminated its conductivity increases and it does not perform well. A contaminated bath can create voids in the conductive coating. Dispersion baths typically need to be replaced every two to five years due to contamination. This replacement adds expense and labor to the printed circuit board manufacturing process.

### SUMMARY OF THE INVENTION

It has been found that the current method and apparatus are useful for recovering a contaminated dispersion bath. Specifically, the current method and apparatus are useful for cleaning a contaminated dispersion bath from contamination caused by drag-in, aging and/or bacterial exchange. The current method and apparatus are useful for removing ionic contaminants from a dispersion bath. The current method and apparatus are also useful for controlling conductivity of the dispersion by keeping conductivity in an appropriate range. Cleaning a contaminated dispersion bath enhances performance, helps maintain a healthy bath and allows the bath to be used longer without replacement. The current method and apparatus are also useful for improving the quality of a dispersion bath during manufacturing.

An embodiment of the current apparatus for treating a dispersion bath having an initial pH comprises at least one ion exchange resin, an ion exchange resin housing wherein the ion exchange resin housing contains the ion exchange resin and allows the dispersion to flow through the ion exchange resin, and optionally a pH adjustor and wherein the ion exchange resin and the optional pH adjustor maintain a pH of within +/−2 of the initial pH of the dispersion bath. In one embodiment the dispersion bath is a colloid bath.

Examples of possible ion exchange resin housings include a permeable plastic bag, a recovery cartridge and an ion exchange resin filled filter.

In one embodiment the ion exchange resin is a mixed bed resin having an anion exchange speed and a cation exchange speed that are substantially similar such that the pH does not vary outside of +/−2 of the initial pH of the dispersion bath.

In another embodiment the ion exchange resin is a cationic resin having a cation exchange speed such that the pH does not vary outside of +/−2 of the initial pH of the dispersion bath. In this example, the pH adjustor can be a basic pH adjustor that releases OH⁻ ions at a rate such that the pH does not vary outside of +/−2 of the initial pH of the dispersion bath.

In yet another embodiment the ion exchange resin is an anionic resin having an anion exchange speed such that the pH does not vary outside of +/−2 of the initial pH of the dispersion bath. In this example, the pH adjustor can be an acidic pH adjustor that releases H⁺ ions at a rate such that the pH does not vary outside of +/−2 of the initial pH of the dispersion bath.

An embodiment of the current process of treating a dispersion bath, comprises providing a dispersion bath having an initial pH, providing an ion exchange resin wherein the ion exchange resin, optionally providing a pH adjustor, and flowing the dispersion through the ion exchange resin wherein the ion exchange resin and the optional pH adjustor maintain a pH of within +/−2 of the initial pH of the dispersion bath. In one embodiment the dispersion bath is a colloid bath.

The process can further comprise providing an ion exchange resin housing wherein the ion exchange resin housing contains the ion exchange resin and allows the dispersion to flow through the ion exchange resin. Examples of possible ion exchange resin housings include a permeable plastic bag, a recovery cartridge and an ion exchange resin filled filter.

In one embodiment the ion exchange resin is a mixed bed resin having an anion exchange speed and a cation exchange speed that are substantially similar such that the pH does not vary outside of +/−2 of the initial pH of the dispersion bath.

In another embodiment the ion exchange resin is a cationic resin having a cation exchange speed such that the pH does not vary outside of +/−2 of the initial pH of the dispersion bath. In this example, the pH adjustor can be a basic pH adjustor that releases OFF ions at a rate such that the pH does not vary outside of +/−2 of the initial pH of the dispersion bath.

In yet another embodiment the ion exchange resin is an anionic resin having an anion exchange speed such that the pH does not vary outside of +/−2 of the initial pH of the dispersion bath. In this example, the pH adjustor can be an acidic pH adjustor that releases H⁺ ions at a rate such that the pH does not vary outside of +/−2 of the initial pH of the dispersion bath.

The process can also further comprise monitoring conductivity for the dispersion bath. The flowing of the dispersion bath can continue until the conductivity of the dispersion bath is less than 1.2 millisiemens (mS/cm). It could also continue until the conductivity is less than 0.8 mS/cm. The ion exchange resin can be replaced if conductivity stops declining.

### BRIEF DESCRIPTION OF THE DRAWINGS

FIG. 1 is a graph of time into treatment by the current apparatus or method (in minutes) versus conductivity in mS/cm on the left and pH on the right of the treated dispersion bath fluid.

### DETAILED DESCRIPTION OF THE PREFERRED EMBODIMENT(S)

The present methods and apparatuses generally relate to recovering a contaminated dispersion bath. Specifically, the present methods and apparatuses relate to cleaning a contaminated dispersion bath from contamination caused by drag-in, aging and/or bacterial exchange. This enhances performance and lengthens life of the dispersion bath. The current method and apparatus are also useful for improving the quality of a dispersion bath during manufacturing. The embodiments disclosed herein are intended to be illustrative and it will be understood that the invention is not limited to these embodiments since modification can be made by those of skill in the art without departing from the scope of the present disclosure.

One embodiment of current apparatus for recovering a contaminated dispersion bath having an initial pH comprises at least one ion exchange resin, an ion exchange resin housing wherein the ion exchange resin housing contains the ion exchange resin and allows the dispersion to flow through the ion exchange resin, and optionally a pH adjustor wherein the ion exchange resin and the optional pH adjustor maintain a pH of within +/−2 of the initial pH of the dispersion bath. The current apparatus can be used to improve the freshness, performance and life of the dispersion bath. The current apparatus can be used after the bath has become contaminated as a remedial procedure or during manufacture as a preventative procedure.

Specifically, the current apparatus is useful for cleaning a contaminated dispersion bath from contamination caused by drag-in, aging and/or bacterial exchange. The current apparatus is useful for removing ionic contaminants from a dispersion bath. The current apparatus is also useful for controlling conductivity of the dispersion by keeping conductivity in an appropriate range. Cleaning a contaminated dispersion bath enhances performance, helps maintain a healthy bath and allows the bath to be used longer without replacement.

The dispersion bath may be a colloid bath. In some embodiments it may be a colloid bath used for applying a conductive coating to an initially nonconductive through hole during printed circuit board manufacture. In one such embodiment, the colloid bath is comprised of a graphite colloid.

The health of a dispersion bath can be gauged by its conductivity. Conductivity measures the electrical resistance of the bath. Conductivity is an indication of free ions in the bath. A dispersion bath is typically considered healthy at a conductivity of below about 1.2 mS/cm. A dispersion bath is often replaced at a conductivity of above about 2.0 mS/cm. The conductivity can be monitored during the treatment by the current apparatus. For example, the ion exchange resin may be contacted with the dispersion bath to obtain a conductivity of less than about 1.2 mS/cm, alternatively less than about 0.8 mS/cm.

A suitable ion exchange resin known to those in the art may be used in the present apparatus. Ion exchange resins are polymers that are used to remove contaminants and release clean liquid. For example, ion exchange resins have been used to remove sulfates and carbonates from liquids. In one specific example, ion exchange resins are used in the production of deionized water.

A resin for use in the current application could have a number of physical properties. Exemplary properties that would be advantageous for the current application include low total organic carbon (TOC) leachables, low level of impurities, wide pH range operation, and controlled bead particle size uniformity. Controlled bead particle size uniformity enables reliable filtering without escaping beads and possible bath particulate contamination. For example, a bead size of 400-600 microns with a 5% maximum larger than 1200 micron and 0.5% maximum below 250 micron allows a filter screen size of 200 microns during application.

The ion exchange resin has an ion exchange speed. The ion exchange resin may be a cationic resin and the ion exchange speed may be a cation exchange speed. The ion exchange resin may be an anionic resin and the ion exchange speed may be an anion exchange speed. The ion exchange resin may also be a mixed bed resin with an ion exchange speed that is made up of both a cation exchange speed an anion exchange speed. The cation exchange speed is the rate at which an ion exchange resin removes certain contaminants from the dispersion that release positive ions. For example, when an ion exchange resin removes potassium from the dispersion, H⁺ ions are released. The anion exchange speed is the rate at which an ion exchange resin removes certain contaminants from the dispersion that release negative ions. For example, when an ion exchange resin removes sulfates from the dispersion, OH⁻ ions are released.

The current apparatus also optionally contains a pH adjustor. A suitable pH adjustor known to those in the art may be used in the present apparatus. The pH adjustor could be an acid or a base. If the pH adjustor is an acid, ions are released. If pH adjustor is a base, OH⁻ ions are released.

The current apparatus uses an ion exchange resin and optionally a pH adjustor that maintain a pH of within +/−2 of the initial pH of the dispersion bath. A number of resins have an ion exchange speed which causes the pH to vary significantly. For example, when the anion and cation exchange speeds are significantly different, the pH of the dispersion that is being treated may vary significantly. When the cation and anion exchange speeds are equal or similar to each other, the pH will not vary significantly.

The dispersion bath has an initial pH or an initial pH range. This is the pH of the dispersion bath prior to addition of an ion exchange resin. As one example, the dispersion bath could be a neutral dispersion bath having an initial pH of approximately 7.0. As another example, the dispersion bath could be a basic dispersion bath having a pH in the range of 7.0 to 14.0, or more preferably 8.0 to 12.0. As another example, the bath could be an acidic dispersion bath having an initial pH in the range of 0 to 7.0, more preferably 3.0 to 5.0.

The dispersion baths used in manufacture of printed circuit boards are sensitive to changes in pH. The dispersion baths are not stable where the pH changes largely from the initial pH of the dispersion bath. The current apparatus will not be effective, if the pH of the dispersion bath rises or falls too far from the initial pH range during treatment. As another example, the pH remains within +/−2 of the initial pH of the dispersion bath. As another example, the pH remains within +/−1 of the initial pH of the dispersion bath.

This means that an ion exchange resin added to a bath having an initial pH of 7.0 would preferably not change the pH to less than 5.0 or greater than 9.0. As another example, an ion exchange resin added to a bath having an initial pH in the range of 9.0-10.0 would preferably not change the pH to less than 7.0 or greater than 12.0.

In one embodiment the ion exchange resin is a mixed bed resin designed to remove both cations and anions. The anion exchange speed and the cation exchange speed are substantially similar so that the pH does not vary outside of within +/−2 of the initial pH of the dispersion bath. In one embodiment the ion exchange resin is Rohm and Haas AMBERLITE MB20™. In yet another embodiment the ion exchange resin is Siemens NR-6 SG™. Other ion exchange resins with cation and anion exchange speeds that are equal or similar could also be used. As one example, the ion exchange resin can be a high capacity weak acid cation exchange resin. The ion exchange resin can contain carboxylic acid groups on an acrylic matrix. In yet another example the ion exchange resin can be a mixed bed 50/50 resin.

In another embodiment the ion exchange resin is a cationic resin designed to remove cations. The cation exchange speed of the resin could be such that the pH does not vary outside of within +/−2 of the initial pH of the dispersion bath.

In another embodiment the ion exchange resin is an anionic resin designed to remove anions. The anion exchange speed of the resin could be such that the pH does not vary outside of within +/−2 of the initial pH of the dispersion bath. In one embodiment the ion exchange resin is Siemens USF A-284 SG™. The ion exchange resin can be an anionic (OH−) exchange resin, a Type I strong base anion (SBA) resin or a weak base anion (WBA) Type II resin.

In yet another embodiment the ion exchange resin is a cationic resin designed to remove cations and a basic pH adjustor is added. The cation exchange speed of the resin and rate at which the OH⁻ ions are released by the pH adjustor could be such that the pH does not vary outside of within +/−2 of the initial pH of the dispersion bath.

In yet another embodiment the ion exchange resin is an anionic resin designed to remove anions and an acidic pH adjustor is added. The anion exchange speed of the resin and the rate at which H⁺ ions are released by the pH adjustor could be such that the pH does not vary outside of within +/−2 of the initial pH of the dispersion bath.

The ion exchange resin and optionally pH adjustor may be present in an amount suitable to recover a contaminated dispersion bath. The amount of resin and optionally pH adjustor needed to recover a contaminated bath depends on a number of factors, including the level of contamination of the bath. By way of example, the ion exchange resin may be present in the ion exchange resin housing at about 1 gram of resin per liter of dispersion to about 1000 grams of resin per liter of dispersion, alternatively at about 1 gram of resin per liter of dispersion to about 50 grams of resin per liter of dispersion.

The amount of ion exchange resin and optionally pH adjustor appropriate for recovering a dispersion bath can vary from one dispersion bath to another. The amount of ion exchange resin and optionally pH adjustor appropriate for recovering a particular dispersion bath can be determined using mathematic interpolation and a small scale pre-test. A small amount of the dispersion fluid is placed in a lab vessel with a magnetic stirrer. A small amount of ion exchange resin and optionally pH adjustor is placed into the lab vessel. The dispersion fluid and ion exchange resin are contacted for a desired treatment time. The conductivity of the dispersion is measured. If the conductivity is at a healthy level, the amount of resin and optionally pH adjustor and the amount of dispersion fluid used in the small scale pre-test can be interpolated to production volume to determine the amount of ion exchange resin appropriate for the particular dispersion bath. For example, 50 mL of the dispersion fluid is placed in a lab vessel with a magnetic stirrer and 4 g of ion exchange resin. The dispersion fluid and ion exchange resin are contacted for 20 minutes. The conductivity of the dispersion is measured. If the conductivity is less than about 1.2 mS/cm, the amount of resin and the amount of dispersion fluid used in the small scale pre-test can be interpolated to production volume to determine the amount of ion exchange resin appropriate for the particular dispersion bath.

The ion exchange resin housing contains the ion exchange resin and allows the dispersion to flow through the ion exchange resin and contact the ion exchange resin. In one example, the ion exchange resin housing can be a permeable plastic bag. For example, the plastic could by nylon, polypropylene, polyethylene or other plastics. The permeable plastic bag can be filled with ion exchange resin, sealed and placed into the dispersion bath. In another example, the ion exchange resin housing can be a recovery cartridge. The recovery cartridge contains the ion exchange resin framed by a fine mesh. The fine mesh allows the dispersion to flow through and contact the ion exchange resin. In yet another example the ion exchange resin housing can be an ion exchange resin filled filter. As the dispersion flows through the filter it would contact the resin within the filter. In yet another example the ion exchange resin could be added to the dispersion and then filtered out using a basic filter. Other housings that can contain the ion exchange resin and allow the dispersion to flow through the ion exchange resin can also be used.

In other embodiments optional components that will not compromise the recovery process can also be added. Non-limiting examples of such optional components include a pH monitor, a conductivity monitor, a mechanism to agitate the resin, components to automate the apparatus or additional chemicals. In one example, small amounts of ammonia (NH₃) may be added to the dispersion liquid.

The current method of recovering a contaminated dispersion bath comprises providing a dispersion bath having an initial pH, providing an ion exchange resin, optionally providing a pH adjustor and flowing the dispersion through the ion exchange resin, wherein the ion exchange resin and the optional pH adjustor maintain a pH of within +/−2 of the initial pH of the dispersion bath. The current method can be used to improve the freshness, performance and life of the dispersion bath. The current method can be used after the bath has become contaminated as a remedial procedure or during manufacture as a preventative procedure.

The current method can further comprise providing an ion exchange resin housing wherein the ion exchange resin housing contains the ion exchange resin and allows the dispersion to flow through the ion exchange resin and flowing the dispersion through the ion exchange resin housing and the ion exchange resin.

Specifically, the current method is useful for cleaning a contaminated dispersion bath from contamination caused by drag-in, aging and/or bacterial exchange. The current method is useful for removing ionic contaminants from a dispersion bath. The current method is also useful for controlling conductivity of the dispersion by keeping conductivity in an appropriate range. Cleaning a contaminated dispersion bath enhances performance, helps maintain a healthy bath and allows the bath to be used longer without replacement.

The dispersion bath may be a colloid bath. In some embodiments it may be a colloid bath used for applying a conductive coating to an initially nonconductive through hole during printed circuit board manufacture. In one embodiment, the colloid bath is comprised of a graphite colloid.

As discussed above, a suitable ion exchange resin known to those in the art may be used in the present method. A suitable pH adjustor may also be used. The current method will not be effective, if the pH of the dispersion bath falls outside of the pH range of about within +/−2 of the initial pH of the dispersion bath during treatment.

In one embodiment the ion exchange resin is a mixed bed resin designed to remove both cations and anions. The anion exchange speed and the cation exchange speed are substantially similar so that the pH does not vary outside of within +/−2 of the initial pH of the dispersion bath. In one embodiment the ion exchange resin is Rohm and Haas AMBERLITE MB20™. In yet another embodiment the ion exchange resin is Siemens NR-6 SG™. Other ion exchange resins with cation and anion exchange speeds that are equal or similar could also be used.

In another embodiment the ion exchange resin is a cationic resin designed to remove cations. The cation exchange speed of the resin could be such that the pH does not vary outside of within +/−2 of the initial pH of the dispersion bath.

In another embodiment the ion exchange resin is an anionic resin designed to remove anions. The anion exchange speed of the resin could be such that the pH does not vary outside of within +/−2 of the initial pH of the dispersion bath.

In yet another embodiment the ion exchange resin is a cationic resin designed to remove cations and a basic pH adjustor is added. The cation exchange speed of the resin and the rate at which OH⁻ ions are released by the pH adjustor could be such that the pH does not vary outside of within +/−2 of the initial pH of the dispersion bath.

In yet another embodiment the ion exchange resin is an anionic resin designed to remove anions and an acidic pH adjustor is added. The anion exchange speed of the resin and the rate at which H⁺ ions are released by the pH adjustor could be such that the pH does not vary outside of within +/−2 of the initial pH of the dispersion bath.

The ion exchange resin and optionally pH adjustor may be present in an amount suitable to recover a contaminated dispersion bath. By way of example, the ion exchange resin may be present in the ion exchange resin housing at about 1 gram of resin per liter of dispersion to about 1000 grams of resin per liter of dispersion, alternatively at about 1 gram of resin per liter of dispersion to about 50 grams of resin per liter of dispersion. As discussed above, the amount of ion exchange resin and optionally pH adjustor appropriate for recovering a particular dispersion bath can be determined using mathematic interpolation and a small scale pre-test.

The current method may take place at a temperature suitable to obtain the desired dispersion bath recovery. For example, the desired result may be achieved at room temperature or at the typical operating temperature of the dispersion bath. In one example, the temperature during treatment is in the range from about 50° F. to about 86° F. (about 10° C. to about 30° C.).

The current method may take place for a duration of time suitable to obtain the desired dispersion bath recovery. For example, the desired result may be achieved where the ion exchange resin is contacted with the dispersion for about 15 minutes to about 120 minutes. The time suitable to obtain the desired dispersion bath recovery could depend on the quality of contact between the dispersion and the ion exchange resin. For example, contact could be improved with agitation of the dispersion bath in order to only require contact for about 60 minutes. Without agitation, the time required might be as long as a day.

The current method may take place for a duration of time suitable to obtain the desired conductivity in the dispersion bath. A dispersion bath is healthy at a conductivity of below about 1.2 mS/cm. A dispersion bath is often replaced at a conductivity of above about 2.0 mS/cm. The conductivity can be monitored during the treatment. For example, the ion exchange resin may be contacted with the dispersion bath to obtain a conductivity of less than about 1.2 mS/cm, alternatively less than about 0.8 mS/cm. If the conductivity stops declining prior to reaching the desired level, the ion exchange resin can be replaced.

The ion exchange resin housing contains the ion exchange resin and allows the dispersion to flow through the ion exchange resin. In one example, the ion exchange resin housing can be a permeable plastic bag. The permeable plastic bag can be filled with ion exchange resin, sealed and placed into the dispersion bath. In another example, the ion exchange resin housing can be a recovery cartridge. In yet another example the ion exchange resin housing can be an ion exchange resin filled filter. Other housings that can contain the ion exchange resin and allow the dispersion to flow through the ion exchange resin can also be used.

Additional optional steps may also be added. For example steps could be added to monitor pH, to agitate the dispersion around the ion exchange resin and to automate the current method.

A person familiar with the technology will understand that the conditions described above can be varied and adjusted to achieve the desired dispersion bath recovery.

### Example 1

In one non-limiting embodiment, a 50 mL sample was taken from a contaminated colloid bath. The sample contained a graphite colloid. The sample had a conductivity of 2.3 mS/cm and a pH of 8.8 prior to treatment. The sample was placed in a beaker with 3.2 g of Rohm and Haas AMBERLITE MB20™ and stirred using a magnetic stir bar. The conductivity and pH were measured. The sample after treatment had a conductivity of 1.4 mS/cm and a pH of 8.8. Another 3.2 g of Rohm and Haas AMBERLITE MB20™ was added and stirred using a magnetic stir bar. The conductivity and pH were measured again. The sample after a second treatment had a conductivity of 0.8 mS/cm and a pH of 8.6. Treatment decreased the conductivity of the sample while maintaining the pH within +/−2 of the initial pH of the dispersion bath.

### Example 2

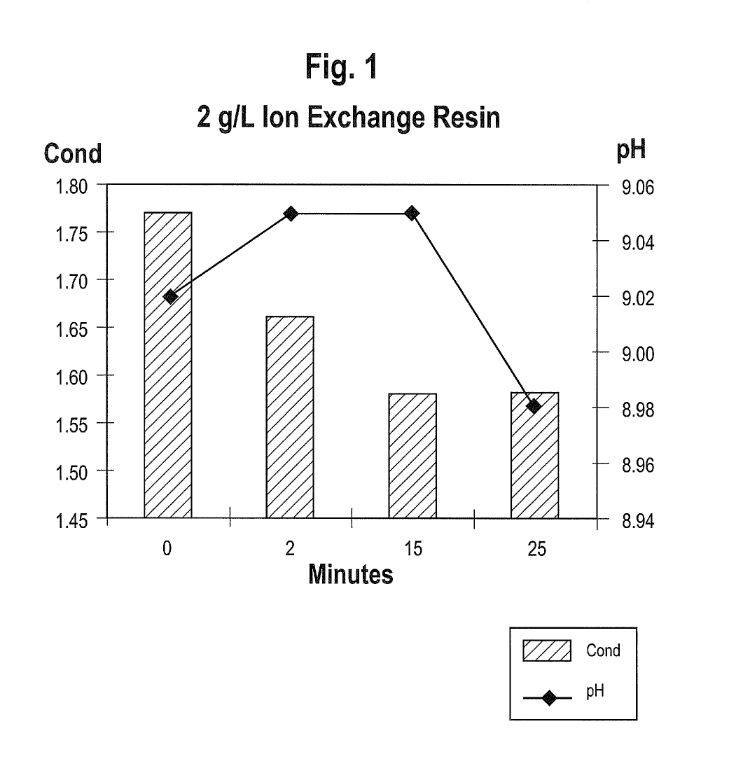

In one non-limiting embodiment, a 1 L sample was taken from a contaminated colloid bath. The sample contained a graphite colloid. The sample was placed in a beaker with 2 g of Siemens NR-6 SG™ and stirred using a magnetic stir bar. The conductivity and pH of the sample were measured at 0, 2, 15 and 25 minutes into treatment. FIG. 1 is a graph showing the conductivity and pH of the sample at 0, 2, 15 and 25 minutes into treatment. FIG. 1 shows time into treatment by the current apparatus or method (in minutes) versus conductivity (in mS/cm) on the left and pH on the right of the sample. Treatment decreased the conductivity of the sample while maintaining the pH within +/−2 of the initial pH of the dispersion bath.

### Example 3

In one non-limiting embodiment, a 1 L sample was taken from a contaminated colloid bath. The sample contained a graphite colloid. The sample was placed in a beaker with 6.25 g of Siemens NR-6 SG™ and stirred using a magnetic stir bar for 10-15 minutes. The sample's pH, conductivity (mS/cm) and concentration of chlorides, nitrites, nitrates, sulfates (ppm) were measured before and after treatment. The following table shows the results of the measurements.

TABLE 1
Analysis of a Sample from a Contaminated Colloid Bath Before
and After Treatment with 6.25 g/L of Siemens NR-6 SG ™

| Value | Prior to | After |
|---|---|---|
| Measured | Treatment | Treatment |
| pH | 9.3 | 9.4 |
| Conductivity | 2.5 | 1.8 |
| (mS/cm) | | |
| [Chloride] | 23 | 20 |
| (ppm) | | |
| [Nitrite] | 526 | 339 |
| (ppm) | | |
| [Nitrate] | 23 | 15 |
| (ppm) | | |
| [Sulfate] | 56 | 48 |
| (ppm) | | |

Treatment decreased the sample's conductivity and concentration of chlorides, nitrites, nitrates, sulfates (ppm) while maintaining the pH within +/−2 of the initial pH of the dispersion bath.

### Example 4

In one non-limiting embodiment, a 1 L sample was taken from a contaminated colloid bath. The sample contained a graphite colloid. The sample was placed in a beaker with 6.25 g of Siemens NR-6 SG™ and stirred using a magnetic stir bar for 10-15 minutes. The sample's pH, conductivity (mS/cm) and concentration of chlorides, nitrites, nitrates and sulfates (all in ppm) were measured before and after treatment. The following table shows the results of the measurements.

TABLE 2
Analysis of a Sample from a Contaminated Colloid Bath Before
and After Treatment with 6.25 g/L of Siemens NR-6 SG ™

| Value | Prior to | After |
|---|---|---|
| Measured | Treatment | Treatment |
| pH | 9.08 | 9 |
| Conductivity | 2.81 | 2 |
| (mS/cm) | | |
| [Chloride] | 22 | 23 |
| (ppm) | | |
| [Nitrite] | 520 | 345 |
| (ppm) | | |
| [Nitrate] | 12 | 9 |
| (ppm) | | |
| [Sulfate] | 7.3 | 18 |
| (ppm) | | |

Treatment decreased the sample's conductivity (mS/cm) and concentration of nitrites, nitrates and sulfates (ppm) while maintaining the pH within +/−2 of the initial pH of the dispersion bath.

### Example 5

In one non-limiting embodiment, a 1 L sample was taken from a contaminated colloid bath. The sample contained a graphite colloid. The sample was placed in a beaker with 6.25 g of Siemens NR-6 SG™ and stirred using a magnetic stir bar for 10-15 minutes. The sample's pH, conductivity (mS/cm), particle size D50 and concentration of chlorides (ppm), nitrites (ppm), nitrates (ppm), sulfates (ppm), carbonates (millinormal or mN) and copper (ppm) were measured before and after treatment. The following table shows the results of the measurements.

TABLE 3
Analysis of a Sample from a Contaminated Colloid Bath Before
and After Treatment with 6.25 g/L of Siemens NR-6 SG ™

| Value | Prior to | After |
|---|---|---|
| Measured | Treatment | Treatment |
| pH | 9.01 | 9.07 |
| Conductivity | 1.95 | 1.5 |
| (mS/cm) | | |
| [Chloride] | 41 | 23 |
| (ppm) | | |
| [Nitrite] | 29 | 18 |
| (ppm) | | |
| [Nitrate] | 29 | 7 |
| (ppm) | | |
| [Sulfate] | 98 | 25 |
| (ppm) | | |
| [Carbonate] | 27 | 20 |
| (mN) | | |
| [Copper] | 983 | 819 |
| (ppm) | | |
| Particle size | 0.906 | 0.877 |
| D50 | | |

Treatment decreased the sample's conductivity, particle size, and concentration of chlorides, nitrites, nitrates, sulfates, carbonates and copper while maintaining the pH within +/−2 of the initial pH of the dispersion bath.

### Example 6

In one non-limiting embodiment, a contaminated colloid bath used in printed circuit board manufacture was treated. The sample contained a graphite colloid. The colloid bath sump volume was 144 L. One kg of Siemens NR-6 SG™ resin was pumped into the colloid bath at a rate of 15 L/min. The treatment of the colloid by the resin lasted for 30 minutes. The sample's pH, conductivity, alkalinity and concentration of carbonates and copper were measured before and after treatment. The following table shows the results of the measurements.

TABLE 4
Analysis of a 144 L Contaminated Colloid Bath Before
and After Treatment with 1 kg of Siemens NR-6 SG ™

| Value | Prior to | After |
|---|---|---|
| Measured | Treatment | Treatment |
| pH | 9.14 | 9.11 |
| Conductivity | 1.68 | 1.07 |
| (mS/cm) | | |
| [Alkalinity] | 11 | 7.4 |
| (mN) | | |
| [Copper] | 70 | 57 |
| (ppm) | | |
| [Carbonate] | 17.4 | 8.2 |
| (mN) | | |

Treatment decreased the sample's conductivity, alkalinity and concentration of carbonates and copper while maintaining the pH within +/−2 of the initial pH of the dispersion bath. Two test panels were processed using the bath before and after resin treatment. Voids were not detected on either panel.

### Example 7

In one non-limiting embodiment, a contaminated colloid bath used in printed circuit board manufacture was treated. The sample contained a graphite colloid. The colloid bath volume was 50 gallons. 500 g (approximately 45 in³) of Siemens NR-6 SG™ resin was pumped into the colloid bath at a rate of 15 L/min. The recirculation time of the resin lasted for 15 minutes (the time of approximately one bath turn over). The sample's percent of solids, pH, conductivity, viscosity (centipoise or cps), average particle size in microns, and concentration of copper, chlorides, nitrites, nitrates, and sulfates were measured before and after treatment. Visual and magnified glass slide tests were also carried out. In the glass slide test the colloid dispersion is dripped onto a glass slide and allowed to dry. The glass slide is then examined visually with the bare eye and with a microscope. If the colloid bath creates and even coating, the colloid bath passes the glass slide test. If the colloid bath creates a coating with voids or holes, the colloid bath fails the glass slide test. The following table shows the results of the measurements.

TABLE 5
Analysis of a 50 Gallon Contaminated Colloid Bath Before
and After Treatment with 500 g of Siemens NR-6 SG ™

| Value | Prior to | After |
|---|---|---|
| Measured | Treatment | Treatment |
| Solids (%) | 3.20 | 3.20 |
| pH | 8.57 | 8.27 |
| Conductivity | 1.94 | 1.59 |
| (mS/cm) | | |
| [Copper] | 534 | 489 |
| (ppm) | | |
| [Chloride] | 32 | 25 |
| (ppm) | | |
| [Nitrite] (ppm) | 347 | 185 |
| [Nitrate] | 9 | 0 |
| (ppm) | | |
| [Sulfate] | 68 | 18 |
| (ppm) | | |
| Glass Slide | fail | pass |
| (visual) | | |
| Glass Slide | 5 | 10 |
| (magnified) | | |
| Viscosity (cps) | 10 | 6 |
| Particle Size | 0.871 | 0.674 |
| (micron) | | |

Treatment decreased the sample's conductivity (mS/cm), viscosity, particle size, and concentration of copper, chlorides, nitrites, nitrates, and sulfates while maintaining the pH within +/−2 of the initial pH of the dispersion bath. Glass slide tests performance also improved.

### Example 8

In one non-limiting embodiment, a contaminated colloid bath used in printed circuit board manufacture was treated. The sample contained a graphite colloid. No pump was used. 1.2 kg of Siemens NR-6 SG™ was put in an anode bag and placed into the colloid bath sump near the pump return. The sump volume was approximately 340 L. The treatment by the resin lasted for 30 minutes. The sample's conductivity (mS/cm), viscosity (cps), particle size (microns), and concentration of nitrites and sulfates were measured before and after treatment. A glass slide test was also carried out. The following table shows the results of the measurements.

TABLE 6
Analysis of A 340 L Contaminated Colloid Bath Before
and After Treatment with ~3.5 g/L of Siemens NR-6 SG ™

| Value | Prior to | After |
|---|---|---|
| Measured | Treatment | Treatment |
| Conductivity | 3.08 | 2.00 |
| (mS/cm) | | |
| Glass Slide | 5 | 8 |
| Viscosity (cps) | 24 | 5 |
| Particle Size | 0.719 | 0.583 |
| (micron, D50) | | |
| [Nitrite] (ppm) | 653 | 368 |
| [Sulfate] | 75 | 15 |
| (ppm) | | |

Treatment decreased the sample's conductivity, viscosity, particle size, and concentration of nitrites, and sulfates. Glass slide test performance also improved.

### Example 9

In one non-limiting embodiment, a contaminated colloid bath used in printed circuit board manufacture was treated. The sample contained a graphite colloid. The colloid bath contained 110 L. 4 kg of Rohm and Haas AMBERLITE MB20™ and 40 mL of NH₃ was put in a 120 μm mash bag and connected into a mixing or filter pump of the colloid bath apparatus. The sample's conductivity (mS/cm) and pH were monitored throughout treatment. The sample's percent of solids, pH, conductivity (mS/cm), and concentration of copper, chlorides, nitrites, nitrates, and sulfates were measured before and after treatment. A glass slide test was also carried out. The following table shows the results of the measurements.

TABLE 7
Analysis of A 110 L Contaminated Colloid Bath Before and After
Treatment with 4 kg of Rohm and Haas AMBERLITE MB20 ™

| Value | Prior to | After |
|---|---|---|
| Measured | Treatment | Treatment |
| Solids (%) | 2.7 | 2.6 |
| PH | 8.79 | 8.81 |
| Conductivity | 2.51 | 0.55 |
| (mS/cm) | | |
| [Copper] | 248 | 248 |
| (ppm) | | |
| [Chloride] | 15 | 20 |
| (ppm) | | |
| [Nitrite] (ppm) | 476 | 21 |
| [Nitrate] | 13 | 7 |
| (ppm) | | |
| [Sulfate] | 0 | 0 |
| (ppm) | | |
| Glass Slide | fail | pass |
| (visual) | | |

Treatment decreased the sample's percent solids, conductivity and concentration of chlorides, nitrites and nitrates while maintaining the pH within +/−2 of the initial pH of the dispersion bath. Glass slide test performance also improved.

### Example 10

In one non-limiting embodiment, a contaminated colloid bath used in printed circuit board manufacture is treated. The sample contains a graphite colloid. The colloid bath contains 25 gallons. The bath has a conductivity of 2.0 mS/cm. The machine for operating the colloid bath used in printed circuit board manufacture is switched into manual mode. The upper rollers (located above the flood system) from the machine are removed. Three plastic bags are filled with 2 lbs of Rohm and Haas AMBERLITE MB20™ each. The plastic bags are placed into the upper machine chamber. The plastic bags are placed in the direction that colloid fluid flowed through the bags. Each flood bar has its own bag. The internal cover is placed on top of the bags to avoid splashing. The module is closed and the flood pump is started. Conductivity and pH are monitored through treatment. The treatment lasts for 20-120 minutes or until a conductivity of 0.94-1.0 mS/cm is achieved. If conductivity stops declining, bags can be removed and the resin can be replaced.

While particular elements, embodiments and applications have been shown and described, it will be understood, of course, that the invention is not limited thereto since modification can be made by those of skill in the art without departing from the scope of the present disclosure, particularly in light of the foregoing teachings.

What is claimed is:

1. An apparatus for treating a dispersion bath having an initial pH comprising:
at least one ion exchange resin;
an ion exchange resin housing wherein the ion exchange resin housing contains the ion exchange resin and allows the dispersion to flow through the ion exchange resin; and
optionally a pH adjustor
wherein the ion exchange resin and the optional pH adjustor maintain a pH of within +/−2 of the initial pH of the dispersion bath.

2. The apparatus of claim 1 wherein said dispersion bath is a colloid bath.

3. The apparatus of claim 1 wherein said ion exchange resin housing is a permeable plastic bag.

4. The apparatus of claim 1 wherein said ion exchange resin housing is a recovery cartridge.

5. The apparatus of claim 1 wherein said ion exchange resin housing is an ion exchange resin filled filter.

6. The apparatus of claim 1 wherein said ion exchange resin is a mixed bed resin having an anion exchange speed and a cation exchange speed that are substantially similar such that the pH does not vary outside of +/−2 of the initial pH of the dispersion bath.

7. The apparatus of claim 1 wherein said ion exchange resin is a cationic resin having a cation exchange speed such that the pH does not vary outside of +/−2 of the initial pH of the dispersion bath.

8. The apparatus of claim 1 wherein said ion exchange resin is an anionic resin having an anion exchange speed such that the pH does not vary outside of +/−2 of the initial pH of the dispersion bath.

9. The apparatus of claim 7 wherein said pH adjustor is a basic pH adjustor that releases Off ions at a rate such that the pH does not vary outside of +/−2 of the initial pH of the dispersion bath.

10. The apparatus of claim 8 wherein said pH adjustor is an acidic pH adjustor that releases H⁺ ions at a rate such that the pH does not vary outside of +/−2 of the initial pH of the dispersion bath.

11. A process of treating a dispersion bath, comprising:
providing a dispersion bath having an initial pH;
providing an ion exchange resin;
optionally providing a pH adjustor; and
flowing the dispersion through the ion exchange resin
wherein the ion exchange resin and the optional pH adjustor maintain a pH of within +/−2 of the initial pH of the dispersion bath.

12. The process of claim 11 wherein said dispersion bath is a colloid bath.

13. The process of claim 11 further comprising providing an ion exchange resin housing wherein the ion exchange resin housing contains the ion exchange resin and allows the dispersion to flow through the ion exchange resin.

14. The process of claim 13 wherein said ion exchange resin housing is a permeable plastic bag.

15. The process of claim 13 wherein said ion exchange resin housing is a recovery cartridge.

16. The process of claim 13 wherein said ion exchange resin housing is an ion exchange resin filled filter.

17. The process of claim 11 further comprising monitoring conductivity for said dispersion bath.

18. The process of claim 17 wherein said flowing continues until said conductivity of said dispersion bath is less than 1.2 mS/cm.

19. The process of claim 17 wherein said flowing continues until said conductivity of said dispersion bath is less than 0.8 mS/cm.

20. The process of claim 17 wherein said ion exchange resin is replaced if conductivity stops declining.

21. The process of claim 11 wherein said ion exchange resin is a mixed bed resin having an anion exchange speed and a cation exchange speed that are substantially similar such that the pH does not vary outside of +/−2 of the initial pH of the dispersion bath.

22. The process of claim 11 wherein said ion exchange resin is a cationic resin having a cation exchange speed such that the pH does not vary outside of +/−2 of the initial pH of the dispersion bath.

23. The process of claim 11 wherein said ion exchange resin is an anionic resin having an anion exchange speed such that the pH does not vary outside of +/−2 of the initial pH of the dispersion bath.

24. The process of claim 11 wherein said pH adjustor is a basic pH adjustor that releases OH⁻ ions at a rate such that the pH does not vary outside of +/−2 of the initial pH of the dispersion bath.

25. The process of claim 11 wherein said pH adjustor is an acidic pH adjustor that releases H⁺ ions at a rate such that the pH does not vary outside of +/−2 of the initial pH of the dispersion bath.
